(19) United States
(12) Patent Application Publication
(10) Pub. No.: US 2014/0366979 A1
(43) Pub. Date: Dec. 18, 2014

(54) Plastic Hose with Antistatic/Dissipative Properties

(71) Applicant: NORRES Beteiligungs-GmbH, Gelsenkirchen (DE)

(72) Inventor: Burkhard Mollen, Essen (DE)

(21) Appl. No.: 14/300,753

(22) Filed: Jun. 10, 2014

(30) Foreign Application Priority Data
Jun. 13, 2013 (DE) 10 2013 106 164.8

(51) Int. Cl. F16L 11/08

(52) U.S. Cl. CPC F16L 11/08
USPC 138/138; 138/137

(57) ABSTRACT

A plastic hose with antistatic properties, comprising: a hose wall of plastic and a reinforcement of plastic, wherein the reinforcement has a higher stiffness than the hose wall. The equalizing of charge concentrations within the hose and the conduction of electrical charges away from the hose is to be ensured by means of an inner layer of an antistatic/dissipative or electrically conducting plastic.

### CROSS-REFERENCE TO RELATED APPLICATION

This application claims priority to German Patent Application No. 10 2013 106 164.8 filed Jun. 13, 2013, the disclosure of which is hereby incorporated in its entirety by reference.

### BACKGROUND OF THE INVENTION

1. Field of the Invention

The invention concerns a hose with antistatic properties, comprising: a hose wall of plastic and a reinforcement of plastic, wherein the reinforcement has a higher stiffness than the hose wall.

2. Description of Related Art

In the field of hose technology many different types of hoses are of known art. By virtue of its advantageous properties as a material, plastic is often deployed in the manufacture of hoses. Such hoses are designated as plastic hoses or all-plastic hoses.

A requirement for plastic hoses is that electrical charge concentrations must be equalized or conducted away reliably. The types of plastics typically used for the manufacture of hoses are electrically insulating. The consequence is that electrical charge concentrations, which occur, for example, as a result of the friction of the conveyed material (e.g. bulk solids, powders or chippings) against the inner surface of the hose, cannot be conducted away. Excessive charges in plastic hoses can discharge in the form of sparks. As a result high levels of risk can occur, for example, when conveying fluids or gases that are easily ignitable or explosive in nature. A further disadvantage of electrical charges lies in the fact that the conveyed material might adhere to the inner surface of the hose, as a result of which the flow resistance is increased, possibly leading to closure of the hose.

In order to solve this problem it has already been proposed in the prior art that plastic hoses be provided with an electrical conductor, for example, an earthing braid. The earthing braid is, for example, laid from the outside onto the hose wall during the manufacture of the hose and there attached. Alternatively the earthing braid can also be integrated into the hose wall, in that the earthing braid is cast into the plastic during the manufacture of the hose, or is enclosed in another manner.

While it is true that charges can be conducted away from the hose by means of the procedure as described, it does also have disadvantages. To an increasing extent all-plastic hoses are also manufactured in a heavier form, that is to say, with a greater wall thickness and thicker reinforcement. The consequence is that an earthing braid provided in the hose, which typically has a very small cross-sectional area, is surrounded by a relatively large quantity of insulating plastic. The result is that electrical charge carriers that are not located in the immediate vicinity of the earthing braid cannot in fact reach the braid, and thus also cannot be conducted away from the hose.

Increasing the sectional area of the earthing braid also fails to be successful, since on the one hand the material costs would be increased, and on the other hand the properties expected of the plastic hoses, such as a high level of flexibility, would be degraded.

The task underlying the invention is therefore that of configuring and developing a plastic hose, as cited in the introduction and earlier described in detail, such that the equalizing of charge concentrations within the hose and the conduction of electrical charges away from the hose are ensured.

### SUMMARY OF THE INVENTION

Plastic hoses are distinguished by, amongst other features, variable shaping, high flexibility, low weight and low costs. The properties of various plastics can be combined, in that the hose wall is manufactured from a plastic other than that of the reinforcement. Alternatively the hose wall and the reinforcement can also be manufactured from the same plastic, but can contain different additives in order to achieve different mechanical properties.

In accordance with the invention not only the hose wall and the reinforcement, but also the inner layer, is to be manufactured from plastic, so that the hose takes the form of an all-plastic hose. The inner layer is also designated as an “inliner”. The hose wall and the inner layer are preferably designed in the form of layers, so that the hose takes the form throughout of a multi-layer hose. Conventional plastics are basically electrically insulating. An electrically insulating plastic is understood in particular to be a plastic whose electrical resistance is 10̂9 ohm/m or more. In particular the hose wall and/or the reinforcement can be manufactured from an electrically insulating plastic, since in these parts of the hose other properties such as mechanical load-bearing capacity (reinforcement), a high level of flexibility, and a favourable price (hose wall) are paramount.

In order, nevertheless, to be able reliably to equalize or conduct away charge concentrations that occur as a result of charge separations in the hose, it is proposed in accordance with the invention that the inner layer be manufactured from an antistatic/dissipative or electrically conducting plastic. An antistatic/dissipative plastic is understood to be in particular a plastic whose electrical resistance lies in the range between 10̂3 ohm/m and 10̂9 ohm/m (electrical resistance based on the length of the hose). Here the terms “antistatic” and “dissipative” are used synonymously. An electrically conducting plastic is understood to be in particular a plastic whose electrical resistance is 10̂3 ohm/m or less (electrical resistance based on the length of the hose). These types of plastics have the advantage that charge displacements occurring in the hose can again be equalized, since the charge carriers, in particular electrons, can move and distribute themselves by virtue of the properties of these plastics, in particular by virtue of their electrical conductivity.

In that an inner layer of an antistatic/dissipative or electrically conducting plastic is used in accordance with the invention, unevenly distributed charges can be returned particularly rapidly and effectively into an even distribution. This is because a layer allows the movement of the charge carriers in all directions within the layer, while in thin earthing braids the charges can only move in the direction of the braid.

The arrangement of the layer on the inner face of the hose has a number of advantages. In the first instance many charge displacements or charge concentrations occur as a result of the friction of the conveyed material on the inner surface of the hose. Since it is exactly at this point that the inner layer of an antistatic/dissipative or electrically conducting plastic is provided, in the ideal case the occurrence of charge concentrations can be prevented directly. Moreover an arrangement of the layer on the inner face of the hose has the advantage that conveyed material that is easily ignitable or explosive in nature is protected by the inner layer from spark discharges. Finally, by virtue of the increased contact surface area between hose wall and inner layer, a more reliable bonding between the two materials is achieved than would be possible in the case of metallic earthing braids with small cross-sections.

One configuration of the invention envisages that the inner layer extends over the whole of the inner surface of the hose. In other words the inner layer is to cover the whole of the inner surface of the hose. This has the advantage that the whole of the surface coming into contact with the conveyed material is antistatic/dissipative or electrically conducting, and thus an even charge distribution on the whole of the contact surface between the hose and the conveyed material can be achieved. This reduces the risk of discharges in the form of sparks that could jump across onto the conveyed material that may be explosive in nature. Moreover as a result of covering the whole of the surface area of the inner surface of the hose, the inner layer at both ends of the hose extends over the whole periphery of the inner surface of the hose. This has the advantage that metallic connectors can simply be connected to the ends of the hose and are automatically in contact with the inner layer, so that charges can reliably be conducted away via the connectors (earthing). In contrast, in the case of an earthing braid spiralling around the periphery it must be ensured that the thin earthing braid is specifically connected to the connector, for example, is soldered onto the latter.

In accordance with a further teaching of the invention it is proposed that the thickness of the inner layer be less than the thickness of the hose wall. In particular, provision can be made that the inner layer has a thickness of 1 mm or less, in particular of 0.5 mm or less. A particularly thin inner layer saves on costs, since antistatic/dissipative or electrically conducting plastics are consistently more expensive than conventional plastics. Moreover, with thin inner layers the mechanical properties of the hose, which are primarily determined by the hose wall and the reinforcement, are modified or impaired as little as possible.

In a further configuration of the invention provision is made for the inner layer to have an electrical resistance in the range between 10̂3 ohm/m and 10̂9 ohm/m. Inner layers that fulfil this condition are designated as antistatic or dissipative. Furthermore, provision can be made that the inner layer has an electrical resistance of 10̂3 ohm/m or less. Inner layers that have an electrical resistance of 10̂3 ohm/m or less are designated as electrically conducting. The less the electrical resistance of the inner layer, so much the better is an even charge distribution achieved within the hose, as is the conducting of charges away from the hose. Usually active ingredients or additives such as conducting polymers or conducting carbon blacks are added to the (carrier) plastics in order to achieve the antistatic/dissipative or electrically conducting properties.

In a further design of the invention provision is made for the hose wall to be manufactured from a plastic, in particular TPU (thermoplastic polyurethane), PVC (polyvinyl chloride), TPE (thermoplastic elastomers), or PE (polyethylene), which has a hardness in the range between 50 Shore-A and 90 Shore-A. Shore-A is measured by pressing a needle with a truncated tip into the plastic to be tested so as to measure the penetration depth. The end face of the truncated cone has, as standard, a diameter of 0.79 mm, a cone angle of 35°, an applied weight of 1 kg, and an application time of 15 seconds.

In accordance with a further configuration of the invention provision is made for the reinforcement to be manufactured from a plastic, in particular TPU (thermoplastic polyurethane), PVC (polyvinyl chloride), TPE (thermoplastic elastomers), or PE (polyethylene), with a filler material, in particular, talcum, chalk or glass fibre, which has a hardness in the range between 30 Shore-D and 60 Shore-D. Shore-D is measured, as standard, by pressing a needle that has a 30° cone angle, and a spherical tip with a radius of 0.1 mm, into the plastic to be tested so as to measure the penetration depth. The applied weight is 5 kg and the application time is 15 seconds.

In accordance with a further teaching of the invention it is proposed that the reinforcement be designed in a spiral form. In particular the reinforcement can run spirally about a central axis running along the longitudinal direction of the hose. Alternatively, the reinforcement can run in the form of a ring about the central axis. The reinforcement is understood to take the form of a strengthening of the hose that increases its stiffness. Reinforcement that runs in the form of a spiral or a ring has the advantage that the stiffness of the hose increases in the radial direction such that the cross-sectional area of the hose in the reinforced region remains intact. A sufficiently high radial stiffness is, for example, required in vacuum applications in order to prevent a collapse of the hose. At the same time the bending stiffness of the hose is only insignificantly increased by reinforcement running in the form of a spiral or a ring, so that a hose with reinforcement of this type can continue to be bent and laid in the form of a curve. A further advantage of spiral or ring reinforcements is that the hose can be compressed in the longitudinal direction.

In accordance with a further design of the invention the reinforcement can be integrated into the hose wall, and in particular can be completely enclosed by the material of the hose wall. Alternatively provision can be made that the reinforcement is arranged on the outer surface of the hose wall. An integration of the reinforcement into the hose wall has the advantage that the reinforcement is particularly securely bonded with the hose and cannot separate from the latter. Moreover, in the case of integrated reinforcement both the inner surface and also the outer surface of the hose are embodied in a smooth and even manner. Finally, integrated reinforcement is particularly well protected from environmental influences by the surrounding hose wall. On the other hand, an arrangement of the reinforcement on the outer surface of the hose wall has the advantage of simplified manufacture of the hose. In particular, the reinforcement can be fixed onto the outer surface of the hose wall subsequently.

For purposes of improving the conducting properties in accordance with a further configuration of the invention, a metallic conductor, in particular a braid, can be provided, which is in contact with the inner layer. By the combination of the inner layer of an antistatic/dissipative or electrically conducting plastic and the metallic conductor in contact with the inner layer, even very uneven distributions of charge can be equalized reliably, and very large quantities of charge can be conducted away from the hose reliably.

For this purpose it is further proposed that the metallic conductor be arranged in the form of a spiral between the hose wall and the inner layer. As in the case of the reinforcement, the metallic conductor can, in particular, also have a spiral profile about the central axis. As has already been explained previously for the reinforcement, the spiral arrangement has the advantage of increasing the radial stiffness of the hose and nevertheless maintaining a low bending stiffness for the hose and a high level of compressibility. Moreover, in particular if the reinforcement has the form of a spiral it is advantageous to arrange the metallic conductor also in the form of a spiral, since this simplifies manufacture. A further simplification in manufacture is achieved if the metallic conductor is arranged between two other layers, namely the hose wall and the inner layer, and thus does not need to be integrated into one of the layers.

For purposes of increasing the stiffness of the hose a further design of the invention envisages a strengthening support medium, in particular a yarn, a mesh or a weave, which is arranged between the hose wall and the inner layer. The strengthening support medium supplements the reinforcement and can improve other properties of the hose. For example, the reinforcement can provide a higher radial stiffness for the hose, while the strengthening support medium increases the tensile strength in the longitudinal direction of the hose. Yarns, meshes and weaves have the advantage that they can easily be integrated into the hose, for example during an extrusion process.

For this purpose it is further proposed that the strengthening support medium has electrically conducting threads, in particular copper threads, aluminium threads, or carbon threads. In this manner the improvement of mechanical properties (e.g.

stiffness, strength) can be combined, by means of the strengthening support medium, with the improvement of electrical properties (e.g. conductivity) of the hose. A further improvement of the electrical properties of the hose can be achieved in accordance with a further configuration of the invention, in which not only the inner layer, but also the hose wall and/or the reinforcement, are antistatic/dissipative or electrically conducting. This can also be achieved, for example, by additives that are added to the plastic of the hose wall and/or the reinforcement.

In accordance with a further design of the invention provision is made for the hose to have a constant wall thickness. If the thickness of the wall is maintained, despite the reinforcement, to be the same at all points—that is to say, even in the region of the reinforcement—smooth surfaces can be achieved. Smooth inner surfaces have advantages in terms of fluid mechanics. Smooth outer surfaces enable the hose to be more easily cleaned, and also to be guided more easily over deflection rollers, drums or similar.

Finally, in accordance with a further configuration of the invention, it is proposed that the hose be manufactured from one or a plurality of spirally-wound plastic strips. In particular it is proposed that the hose wall and/or the inner layer be manufactured from a spirally-wound plastic strip. In this form of manufacture a plastic strip is wound in a spiral form, wherein the edge regions of the plastic strip overlap. The overlapping edge regions are subsequently welded or bonded with one another such that reliable sealing of the seam is achieved. In addition a reinforcement or an electrical conductor can also be arranged in the region of the overlap, as a result of which a spiral profile is similarly achieved. By virtue of the spiral winding of plastic strips such a hose is also designated as a “wound hose”; a method for its manufacture is, for example, described in DE 198 48 172 A1.

### BRIEF DESCRIPTION OF THE DRAWINGS

In what follows the invention is explained in further detail with the aid of a drawing representing what is just a preferred example of embodiment. In the figures:

FIG. 1 shows an inventive hose in a first configuration,

FIG. 2 shows the hose from FIG. 1 with a metallic conductor,

FIG. 3 shows the hose from FIG. 1 with a strengthening support medium,

FIG. 4 shows an inventive hose in a second configuration,

FIG. 5 shows an inventive hose in a third configuration, and

FIG. 6 shows an inventive hose with a metallic conductor.

### DESCRIPTION OF THE INVENTION

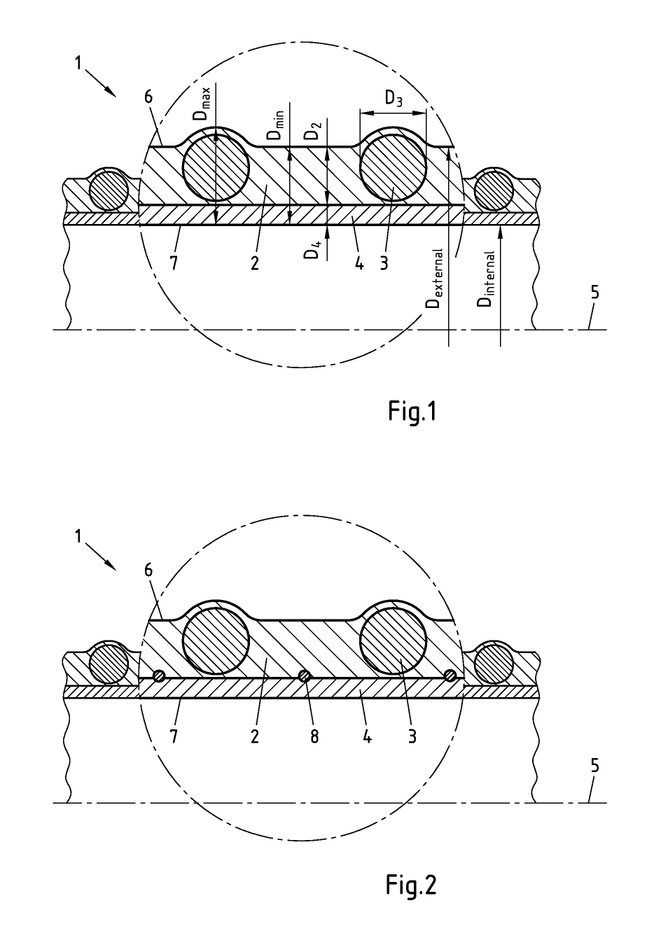

FIG. 1 shows an inventive hose 1 in a first configuration. The representation selected for FIG. 1 takes the form of a section through the hose wall in the longitudinal direction of the hose 1. In FIG. 1 and in all other figures a sub-region is represented at a magnified scale. The hose 1 comprises a plastic hose wall 2 in the form of a layer, a plastic reinforcement 3 in the form of a spiral, and an inner layer 4 in the form of a layer, which likewise is manufactured from plastic. The hose wall 2 has a thickness D2 which preferably lies in the range between 2 mm and 10 mm. In the hose 1 represented in FIG. 1 the reinforcement 3 has a round cross-section with a diameter D3, which preferably lies in the range between 2 mm and 6 mm. The inner layer 4 has a thickness D4, which preferably lies in the range between 0.1 mm and 2 mm.

The hose 1 runs symmetrically about a central axis 5 extending in the longitudinal direction of the hose 1, so that in FIG. 1 and in all other figures no representation of the lower half of the hose 1 is required. In the example of embodiment represented in FIG. 1, and in this respect preferred, the reinforcement 3 is designed in the form of a spiral and is integrated into the hose wall 2, such that the reinforcement 3 is fully enclosed by the material of the hose wall 2. The inner layer 4 is manufactured from an antistatic/dissipative, in particular electrically conducting plastic and completely covers the inner face of the hose 1. The hose 1 has an outer surface 6 and an inner surface 7, wherein in the case of the exemplary hose 1 represented in FIG. 1 the outer surface 6 is formed by the hose wall 2, and the inner surface 7 is formed by the inner layer 4. In the region of its outer surface 6 the hose 1 has an outer diameter Dₑₓₜₑᵣₙₐₗ, which preferably lies in the range between 25 mm and 200 mm. Correspondingly in the region of the inner surface 7 the hose 1 has an inner diameter Dᵢₙₜₑᵣₙₐₗ, which lies in the range between 20 mm and 180 mm. By virtue of the significant thickness of the reinforcement 3 the outer surface 6 of the hose 1 is curved outwards in the vicinity of the reinforcement 3. As a consequence the hose 1 has a wall thickness that varies between a minimum wall thickness Dₘᵢₙ and a maximum wall thickness Dₘₐₓ. The minimum wall thickness Dₘᵢₙ preferably lies in the range between 2 mm and 12 mm, and the maximum wall thickness Dₘₐₓ preferably lies in the range between 3 mm and 16 mm.

FIG. 2 shows the hose from FIG. 1 with a metallic conductor 8. Those regions of the hose that have already been described in connection with FIG. 1, are provided in FIG. 2—and in all other figures—with corresponding reference symbols. In the exemplary hose 1 represented in FIG. 2 the metallic conductor 8 is designed as a braid with a circular cross-section. The metallic conductor 8 runs in the form of a spiral and is arranged between the hose wall 2 and the inner layer 4 such that the metallic conductor 8 is in continuous contact with the inner layer 4 and touches the latter.

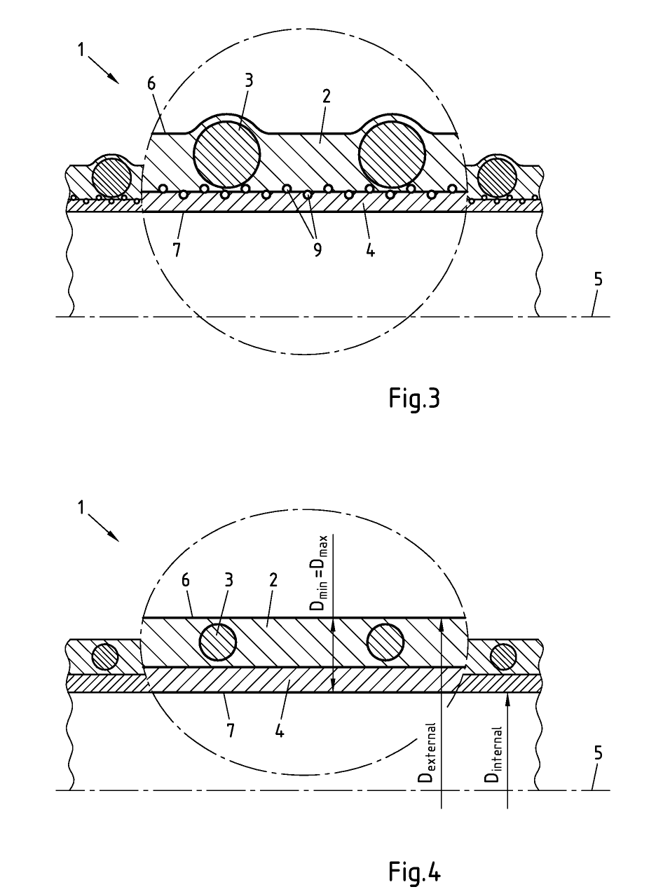

In FIG. 3 the hose 1 from FIG. 1 is shown with a strengthening support medium 9. In the exemplary hose 1 represented in FIG. 3 the strengthening support medium 9 is designed as a mesh or a weave and is arranged between the hose wall 2 and the inner layer 4. The strengthening support medium 9 therefore makes contact with both the hose wall 2 and the inner layer 4 of the hose 1. The strengthening support medium 9 can be combined with the metallic conductor represented in FIG. 2 and/or can itself contain electrically conducting threads or wires.

FIG. 4 shows an inventive hose 1 in a second configuration. There is a difference from the first configuration represented in FIG. 1, in that the outer surface 6 of the hose 1 is not curved outwards in the vicinity of the reinforcement 3. Although in the exemplary hose 1 shown in FIG. 4 the reinforcement 3 is also integrated into the hose wall 2 and completely surrounded by its material, a constant outer diameter Dₑₓₜₑᵣₙₐₗ is achieved, and thus a smooth outer surface 6. The inner diameter Dᵢₙₜₑᵣₙₐₗ is in any event constant, as in FIG. 1, so that the inner surface 7 is also smooth. The hose 1 therefore has a constant wall thickness Dₘᵢₙ=Dₘₐₓ. The reinforcement 3 running in the form of a spiral about the central axis 5 has a circular cross-section in the exemplary hose 1 shown in FIG. 4.

FIG. 5 represents an inventive hose 1 in a third configuration. There is a difference from the second configuration represented in FIG. 4, in that in the exemplary hose 1 represented in FIG. 5 the reinforcement 3 has an oval cross-section.

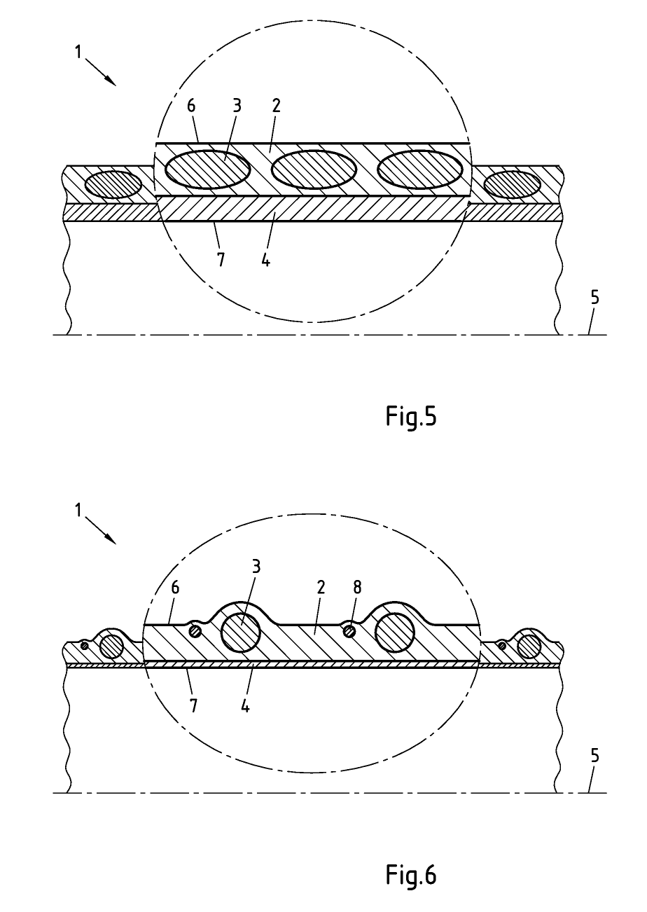

FIG. 6 shows an inventive hose 1 with a metallic conductor 8. There is a difference from the configuration represented in FIG. 2, in that in the exemplary hose 1 represented in FIG. 6 the metallic conductor 8 is integrated into the hose wall 2 and is completely enclosed by the material of the hose wall 2. Moreover the metallic conductor 8 is not in contact with the inner layer 4 and also does not touch the latter. In order to be able, nevertheless, to conduct electrical charges away from the hose 1, it is advantageous in the case of the configuration shown in FIG. 6 if not only the inner layer 4, but also the hose wall 2 and/or the reinforcement 3 are antistatic/dissipative or electrically conducting. In FIG. 6 the metallic conductor 8 also runs in the form of a spiral about the central axis 5 and is arranged outboard in the radial direction, that is to say in the vicinity of the outer surface 6. The consequence is that the outer surface 6 of the hose 1 is curved outwards not only in the vicinity of the reinforcement 3, but also in the vicinity of the metallic conductor 8.

### REFERENCE SYMBOL LIST

1: Hose
2: Hose wall
3: Reinforcement
4: Inner layer
5: Central axis
6: Outer surface
7: Inner surface
8: Metallic conductor
9: Strengthening support medium
D2: Thickness of the hose wall
D3: Diameter of the reinforcement
D4: Thickness of the inner layer
Dₑₓₜₑᵣₙₐₗ: Outer diameter of the hose
Dᵢₙₜₑᵣₙₐₗ: Inner diameter of the hose
Dₘᵢₙ: Minimum wall thickness of the hose
Dₘₐₓ: Maximum wall thickness of the hose

1. A plastic hose with antistatic properties, comprising:
a hose wall of plastic,
a reinforcement of plastic, and
an inner layer of an antistatic/dissipative or electrically conducting plastic,
wherein the reinforcement has a higher stiffness than the hose wall, and
wherein the inner layer extends over the whole inner surface of the hose, and has an electrical resistance of 10̂9 ohm/m or less.

2. The hose according to claim 1, wherein the thickness of the inner layer is less than the thickness of the hose wall.

3. The hose the hose according to claim 1, wherein the inner layer has an electrical resistance of 10̂3 ohm/m or less.

4. The hose according to claim 1, wherein the hose wall is manufactured from a plastic, in particular from TPU, PVC, TPE, or PE, which has a hardness in the range between 50 Shore-A and 90 Shore-A.

5. The hose according to claim 1, wherein the reinforcement is manufactured from a plastic, in particular from TPU, PVC, TPE, or PE, with a filler material, in particular talcum, chalk or glass fibre, and has a hardness in the range between 30 Shore-D and 60 Shore-D.

6. The hose according to claim 1, wherein the reinforcement is designed in the form of a spiral.

7. The hose according to claim 1, wherein the reinforcement is integrated into the hose wall.

8. The hose according to claim 1, wherein the reinforcement is arranged on the outer surface of the hose wall.

9. The hose according to claim 1, wherein a metallic conductor, in particular a braid, which is in contact with the inner layer.

10. The hose according to claim 9, wherein the metallic conductor is arranged in the form of a spiral between the hose wall and the inner layer.

11. The hose according to claim 1, wherein a strengthening support medium, in particular a yarn, a mesh, or a weave, which is arranged between the hose wall and the inner layer.

12. The hose according to claim 11, wherein the strengthening support medium has electrically conducting threads, in particular copper threads, aluminium threads, or carbon threads.

13. The hose according to claim 1, wherein the hose wall and/or the reinforcement are also antistatic/dissipative or electrically conducting.

14. The hose according to claim 1, wherein the hose has a constant wall thickness.

15. The hose according to claim 1, wherein the hose is manufactured from one or a plurality of spirally wound plastic strips.
